(19) United States
(12) Patent Application Publication
(10) Pub. No.: US 2012/0249669 A1
(43) Pub. Date: Oct. 4, 2012

(54) SYSTEM AND METHOD FOR PRINTING ON TAPE

(76) Inventor: James Howard Merritt, JR., Waxhaw, NC (US)

(21) Appl. No.: 13/435,109

(22) Filed: Mar. 30, 2012

Related U.S. Application Data
(60) Provisional application No. 61/470,762, filed on Apr. 1, 2011.

(51) Int. Cl. B41J 2/015

(52) U.S. Cl. 347/21

(57) ABSTRACT

A method for printing ink on adhesive tape including providing a tape supply roll having tape wound thereon, unwinding the tape from the roll, printing ink on the side of the tape having a release agent, exposing the release agent and ink to a temperature increase to cure, and rewinding the tape onto a reel. A system for printing ink on adhesive tape.

### CROSS-REFERENCE TO RELATED APPLICATION

This application claims priority to U.S. Provisional Application No. 61/470,762 filed Apr. 1, 2011, the contents of which are incorporated by reference herein.

### TECHNICAL FIELD AND BACKGROUND OF THE INVENTION

The present invention relates generally to systems and methods for printing inks on tapes and other substrates coated with a release agent, and more particularly, to printing systems and methods that apply light energy to a surface having a release agent and applied ink such that the ink can penetrate the release agent, cure and attach to the backside of the tape.

Adhesive tapes typically have a pressure-sensitive adhesive coating on one side and a release coating on one other. The adhesive coating allows the tape to stick to the surface that the tape is applied to. The release coating prevents the tape from sticking to itself, for example, to permit unwinding of a roll. Suitable examples of release coatings include silicone, silicones containing polymers, fluorochemical constituents, fluorochemical-containing polymers, and copolymers containing higher alkyl acrylates, among others.

While release coatings advantageously prevent the adhesion of the adhesive side to the backside of a roll of tape, properties of release coatings disadvantageously prevent inks from bonding to their surface, making it difficult to sufficiently print on tapes without transferring portions of the ink to the adhesive side.

Accordingly, a need exists for permanently applying ink to the backside of adhesive tape.

### BRIEF SUMMARY OF THE INVENTION

In one aspect, a method for printing ink on the release-coated side of adhesive tape is provided herein.

In another aspect, the method includes treating the release agent and applied ink.

In yet another aspect, the method includes treating the release agent and ink with at least one of infrared (IR) and ultraviolet (UV) light.

In yet another aspect, the method includes increasing the temperature of the release agent and ink to cure the ink.

In yet another aspect, the method includes increasing the temperature of the release agent to increase the space between the molecules of the release agent to allow the ink to penetrate, attach and cure.

In yet another aspect, a system is provided herein for printing ink on adhesive tape.

In yet another aspect, the system includes a light source positioned in proximity to tape passing thereby to expose the release agent side and applied ink to at least one of IR and UV light.

In yet another aspect, the system includes a reflector for filtering IR light and directing UV light to the release agent and applied ink.

To achieve the foregoing and other aspects and advantages, in one embodiment a method for printing ink on adhesive tape is provided herein including the steps of:
(a) providing a tape supply roll having a continuous length of tape rolled thereon; (b) unwinding the tape from the supply roll; (c) passing the unwound tape past a printer head and transferring ink onto the side of the tape having a release agent applied thereto; (d) exposing the release agent and applied ink to UV light to increase the temperature of the release agent and the applied ink; and (e) rewinding the tape onto a rewinding reel.

In another embodiment, a system for printing ink on adhesive tape includes a tape supply roll having a continuous length of tape wound thereon, wherein one side of the tape has a release agent applied thereto, a printing head including a printing plate for transferring ink to the side of the tape having the release agent applied thereto, a UV light source in proximity of the tape for directing UV light to the side of the tape having the release agent and ink applied thereto to increase the temperature thereof, and a rewinding roll for winding the unwound tape having cured ink thereon.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic diagram illustrating a first embodiment of a system for printing ink on adhesive tape including a UV light source and reflector; and

FIG. 2 is a schematic diagram illustrating a second embodiment of a system for printing ink on adhesive tape.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Referring to the drawings, systems and methods for printing ink on the backside of tapes and other substrates having a release coating applied thereto are provided herein. The systems and methods provided herein are advantageous in that ink can be permanently adhered to the release-coated side of the tape for substantially the life of the tape without the ink peeling off, being scraped off, or being transferred to the adhesive side, such as when rolled. The systems and methods are advantageous in that no special methods for manufacturing the tape itself are required. Thus, tape can be provided complete and in roll form and subsequently subjected to the methods provided herein. Specifically, tape may be provided in roll form, unwound, subjected to the printing processes disclosed herein, and then rewound. This allows for complete printing customization of existing rolls, such as for advertising and marking purposes, among others.

Printing may be performed on a continuous roll or at discrete intervals as desired. The term “tape” as used herein generally refers to a substrate having adhesive applied to one side thereof and a release agent/coating applied to the other. Tapes may be provided in roll-form or discrete lengths. The methods provided herein may be used on substrates other than tapes.

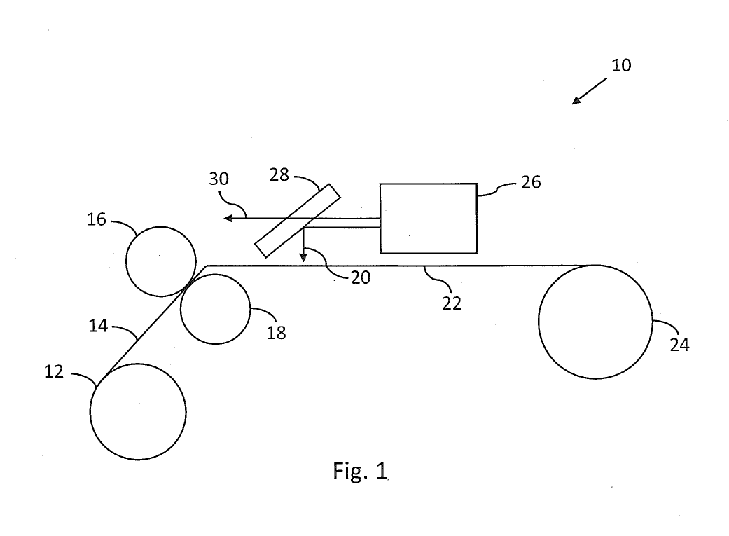

Referring to FIG. 1, a first embodiment of a system for printing ink on adhesive tape is shown generally at reference numeral 10. The system 10 generally includes a tape supply roll 12 that supplies a continuous length of tape 14. The tape 14 unwound from the tape supply roll 12 passes between a printing plate 16 and an opposing support roll 18 of a printing head. As the tape 14 passes by the printing plate 16, ink from the printing plate 14 is transferred to the release coated side of the tape 14.

The tape having the ink applied thereon is then subsequently exposed to ultraviolet (UV) light 20 for a predetermined period of time to cure the applied ink, causing it to hold fast to the tape. After UV exposure and curing, the tape with the cured ink 22 is rewound onto a rewinding reel 24.

The UV light 20 may be produced and supplied using a conventional UV light shown schematically illustrated at reference numeral 26. UV light 20 from the light source 26 is directed to the surface of the tape 14 by way of reflection from a reflector or mirror 28. A significant portion of infrared (IR) light 30 that would impart undesirable heat to the surface of the tape 14 is directed through the reflector 28 and away from the surface of the tape 14.

The UV light 20 raises the temperature of the release coating or agent and cures the ink. Increasing the temperature to an optimal range increases the spaces between the molecules of the release agent, allowing the ink to better penetrate, attach and cure. The increased temperature may result from a combination of UV and IR light, in varying ratios. Other methods for raising the temperature of the release agent to allow incorporation of the ink into the release agent are envisioned.

The temperature increase for promoting adhesion and curing may be in the range from about 50 to 400 degrees F., more preferably from about 80 to 300 degrees F., even more preferably from about 85 to 250 degrees F. The energy for UV curing and temperature increase is preferably in the range from about 5 to 800 mJ/cm², more preferably from about 10 to 600 mJ/cm², even more preferably from about 20 to 400 mJ/cm², and optimally from about 50 to 250 mJ/cm².

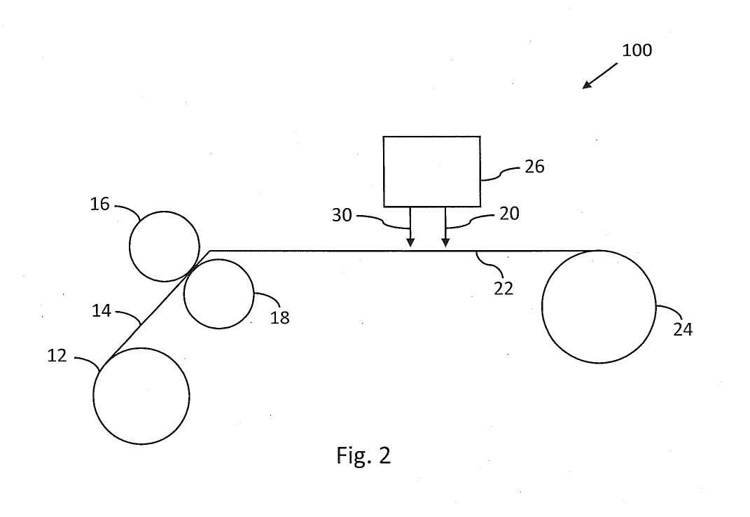

Referring to FIG. 2, a second embodiment of a system for printing ink on adhesive tape is shown generally at reference numeral 100. The system 100 is generally the same as system 10 with the exception of the deletion of the reflector or mirror 28. Thus, in system 100, the UV light 20 and IR light 30 are both imparted to the release agent and applied ink. In either system 10 or 100, UV light harmful to the adhesive may be absorbed by the surrounding surfaces, such as the use of a high temperature flat black paint. The ink may further be premixed with an acrylate to help the ink cure.

According to another embodiment of the invention, a first method for printing ink on adhesive tape is provided herein. The method includes the following steps: (a) providing a tape supply roll having a continuous length of tape rolled thereon; (b) unwinding tape from the supply roll; (c) passing the unwound tape past a printer head and transferring ink onto the side of the tape having a release agent applied thereto; (d) exposing the release agent and applied ink to UV light to cure the ink; and (e) rewinding the tape having the cured ink onto a rewinding reel. The method may optionally include simultaneously exposing the release agent and applied ink to both UV and IR light.

The foregoing description provides embodiments of the invention by way of example only. It is envisioned that other embodiments may perform similar functions and/or achieve similar results. Any and all such equivalent embodiments and examples are within the spirit and scope of the present invention and are intended to be covered by the appended claims.

What is claimed is:

1. A method for printing ink on adhesive tape, comprising the steps of:
(a) providing a tape supply roll having a continuous length of tape rolled thereon;
(b) unwinding the tape from the supply roll;
(c) passing the unwound tape past a printer head and transferring ink onto the side of the tape having a release agent applied thereto;
(d) exposing the release agent and applied ink to UV light to increase the temperature of the release agent and the applied ink; and
(e) rewinding the tape onto a rewinding reel.

2. The method according to claim 1, further comprising the step of simultaneously exposing the release agent and applied ink to both UV and IR light.

3. The method according to claim 1, wherein the temperature is increased from about 50 to 400 degrees F.

4. The method according to claim 1, wherein the temperature is increased from about 80 to 300 degrees F.

5. The method according to claim 1, wherein the temperature is increased from about 85 to 250 degrees F.

6. The method according to claim 1, wherein energy from the UV light is in the range from about 5 to 800 mJ/cm².

7. The method according to claim 1, wherein energy from the UV light is in the range from about 10 to 600 mJ/cm².

8. The method according to claim 1, wherein energy from the UV light is in the range from about 20 to 400 mJ/cm².

9. The method according to claim 1, wherein energy from the UV light is in the range from about 50 to 250 mJ/cm².

10. A system for printing ink on adhesive tape, comprising:
a tape supply roll having a continuous length of tape wound thereon, wherein one side of the tape has a release agent applied thereto;
a printing head including a printing plate for transferring ink to the side of the tape having the release agent applied thereto;
a UV light source in proximity of the tape for directing UV light to the side of the tape having the release agent and ink applied thereto to increase the temperature thereof; and
a rewinding roll for winding the unwound tape having cured ink thereon.

11. The system according to claim 10, further comprising an IR light source.

12. The system according to claim 10, wherein the printing head further includes a support roll opposing the printing plate wherein the tape passes between the support roll and the printing plate.

13. The system according to claim 10, further comprising a reflector directing the UV light to the tape and filtering a substantial portion of IR light.

14. The system according to claim 10, wherein the UV light source is configured to increase the temperature of the tape from about 50 to 400 degrees F.

15. The system according to claim 10, wherein the UV light source is configured to increase the temperature of the tape from about 80 to 300 degrees F.

16. The system according to claim 10, wherein the UV light source is configured to increase the temperature of the tape from about 85 to 250 degrees F.

17. The system according to claim 10, wherein the UV light source produces energy in the range from about 5 to 800 mJ/cm².

18. The system according to claim 10, wherein the UV light source produces energy in the range from about 10 to 600 mJ/cm².

19. The system according to claim 10, wherein the UV light source produces energy in the range from about 20 to 400 mJ/cm².

20. The system according to claim 10, wherein the UV light source produces energy in the range from about 50 to 250 mJ/cm².
